(19) United States
(12) Patent Application Publication
(10) Pub. No.: US 2026/0076379 A1
(43) Pub. Date: Mar. 19, 2026

(54) SHRIMP SORTING SYSTEMS AND METHODS

(71) Applicant: NOVA-TECH ENGINEERING, LLC, Willmar, MN (US)

(72) Inventors: Elliot D. Eid, Willmar, MN (US); Derek Gramstad, New London, MN (US); Brian O'Leary, Litchfield, MN (US); Michael Lambert, Atwater, MN (US); Shaun Remmel, Willmar, MN (US)

(21) Appl. No.: 19/108,593

(22) PCT Filed: Sep. 7, 2023
(86) PCT No.: PCT/US2023/032130

§ 371 Date: Mar. 4, 2025

Related U.S. Application Data
(60) Provisional application No. 63/404,618, filed on Sep. 8, 2022.

(51) Int. Cl. A22C 29/00; A22C 29/02; B65G 11/12; B65G 43/08; B65G 47/46

(52) U.S. Cl. CPC A22C 29/005; A22C 29/023; B65G 11/12; B65G 43/08; B65G 47/46; B65G 2201/0202; B65G 2203/0258

(57) ABSTRACT

The sorting systems and methods described herein provide for the sorting of shrimp. The sorting systems may be combined with a delivery system. The sorting systems employ a pair of rotating slides and optional guide chutes to deliver shrimp to selected delivery locations.

### RELATED APPLICATION

This application claims the benefit under 35 U.S. C. § 119 of U.S. Provisional Application Ser. No. 63/404,618, filed 8 Sep. 2022, and titled SHRIMP SORTING SYSTEMS AND METHODS, which is incorporated herein by reference in its entirety.

### FIELD

Shrimp sorting systems and methods are described herein along with delivery systems for delivering shrimp to the sorting systems.

### BACKGROUND

Shrimp processed for human consumption may be sorted by size. In addition to size, shrimp may be sorted based on the processes performed on the shrimp such as, e.g., heading, peeling, deveining, etc. Sorting of shrimp may be used to facilitate packaging of shrimp having the same or similar physical characteristics for wholesale or retail sales.

### SUMMARY

The shrimp sorting systems and methods described herein provide, in one or more embodiments, for the sorting of shrimp and delivery of the sorted shrimp to selected delivery locations. The sorting systems may be combined with a delivery system used to deliver shrimp for sorting. The sorting systems employ rotating slides to deliver shrimp to selected delivery locations.

In the shrimp processing industry, shrimp may undergo, in addition to (or in place of) weighing or measuring to determine the size of the shrimp, a number of selected processes such as, e.g., heading (to remove the heads of the shrimp), peeling (to remove the shells of the shrimp), deveining (to remove the mud vein for the shrimp), etc. Regarding size, shrimp may be sorted based on their weight and/or length. In one or more embodiments, shrimp may be sorted into weight ranges and/or length ranges. For example, shrimp may be sorted by weight based on how many shrimp would be needed to total one pound, e.g., 8-12 shrimp (sometimes referred to as “Colossal Shrimp”), 13-25 shrimp (sometimes referred to as “Jumbo Shrimp”), 26-35 shrimp (sometimes referred to as “Large Shrimp”), 36-50 shrimp (sometimes referred to as “Medium Shrimp”), and 51-71+ shrimp (sometimes referred to as “Mini Shrimp”).

While some sorting systems exist for shrimp that are processed in bulk exist, sorting of shrimp that are processed individually is typically performed manually (often by the individual also manually performing one or more processes on the shrimp). Sorting systems for bulk processed shrimp are not able to accurately sort shrimp that are processed individually (or are uneconomical to use with individually processed shrimp). Manual sorting of shrimp that have been individually processed by machines is inefficient in addition to carrying over the inaccuracies that plague manual sorting of manually processed shrimp.

The sorting systems described herein are capable of rapidly and accurately sorting shrimp without the disadvantages associated with bulk sorting systems and manual sorting.

In one or more embodiments of the sorting systems and methods described herein in which individual shrimp are sorted, the sorting systems and methods can accurately and efficiently sort shrimp that may have a variety of different physical characteristics. Those physical characteristics may include one or more physical characteristic such as size (based on actual measured or derived weight, length, girth, etc.), heading status (e.g., head on or head off), deveining status (e.g., mud vein removed or not), peeling status (shells and/or pleopods/swimmerets removed or not), etc. The sorting systems and methods can, in one or more embodiments, accurately sort shrimp delivered to the sorting system with any combination of selected physical characteristics even when successive shrimp are delivered to the sorting system with one or more different set of physical characteristics that would require the shrimp to be separated from each other.

In a first aspect, one or more embodiments of a sorting system as described herein includes: a first receiver defining a first passageway extending from a first receiving end to a first transfer end; a second receiver defining a second passageway extending from a second receiving end to a second transfer end; a first slide comprising a first tray located below the first transfer end, the first tray configured to receive a shrimp passing through the first receiver from the first receiving end to the first transfer end, wherein the first slide further comprises a first guide extending from the first tray to a first slide end located below the first tray; a second slide comprising a second tray located below the second transfer end, the second tray configured to receive a shrimp passing through the second receiver from the second receiving end to the second transfer end, wherein the second slide further comprises a second guide extending from the second tray to a second slide end located below the second tray; a first slide actuator operably connected to the first slide end configured to rotate the first slide about a first slide axis, wherein rotation of the first slide about the first slide axis moves the first slide end along a first arc about the first slide axis; a second slide actuator operably connected to the second slide end configured to rotate the second slide about a second slide axis, wherein rotation of the second slide about the second slide axis moves the second slide end along a second arc about the second slide axis; a plurality of delivery locations located below the first slide and the second slide, wherein movement of the first slide end along the first arc moves the first slide end above the plurality of delivery locations and movement of the second slide end along the second arc moves the second slide end above the plurality of delivery locations; and a controller operably connected to the first slide actuator and the second slide actuator, the controller configured to: operate the first slide actuator to rotate the first slide about the first slide axis such that the first slide end is positioned above a first delivery location of the plurality of delivery locations such that each shrimp passing through the first receiver is delivered to the first delivery location after passing along the first slide and exiting the first slide at the first slide end when the first slide end is positioned above the first delivery location; operate the second slide actuator to rotate the second slide about the second slide axis such that the second slide end is positioned above a second delivery location of the plurality of delivery locations such that each shrimp passing through the second receiver is delivered to the second delivery location after passing along the second slide and exiting the second slide at the second slide end when the second slide end is positioned above the second delivery location; operate the first slide actuator to rotate the first slide about the first slide axis such that the first slide end is positioned above the second delivery location such that each shrimp passing through the first receiver is delivered to the second delivery location after passing along the first slide and exiting the first slide at the first slide end when the first slide end is positioned above the second delivery location.

In one or more embodiments of a sorting system as described herein, the controller is configured to operate the first slide actuator to rotate the first slide about the first slide axis such that the first slide end is positioned above a third delivery location of the plurality of delivery locations such that each shrimp passing through the first receiver is delivered to the third delivery location after passing along the first slide and exiting the first slide at the first slide end when the first slide end is positioned above the third delivery location.

In one or more embodiments of a sorting system as described herein, the controller is configured to operate the second slide actuator to rotate the second slide about the second slide axis such that the second slide end is positioned above the third delivery location such that each shrimp passing through the second receiver is delivered to the third delivery location after passing along the second slide and exiting the second slide at the second slide end when the second slide end is positioned above the third delivery location.

In one or more embodiments of a sorting system as described herein, the controller is configured to operate the first slide actuator and the second slide actuator such that the first slide end and the second slide end are both positioned above the third delivery location at the same time such that each shrimp passing through the first receiver and each shrimp passing through the second receiver is delivered to the third delivery location when the first slide end and the second slide end are both positioned above the third delivery location.

In one or more embodiments of a sorting system as described herein, the first slide, the first slide axis, and the first arc are configured to position the first slide end above any selected delivery location of the plurality of delivery locations.

In one or more embodiments of a sorting system as described herein, the second slide, the slide axis, and the second arc are configured to position the second slide end above any selected delivery location of plurality of delivery locations.

In one or more embodiments of a sorting system as described herein, the first slide axis passes through the first tray of the first slide and, optionally, wherein the second slide axis passes through the second tray of the second slide.

In one or more embodiments of a sorting system as described herein, the first slide axis and the second slide axis are oriented generally vertically and/or the first slide axis and the second slide axis are aligned with each other.

In one or more embodiments of a sorting system as described herein, the controller is configured to: receive a signal indicative of a first physical characteristic of each shrimp passing through the first receiver, wherein, optionally, the first physical characteristic is one of: a selected weight range, a selected length range, heading status, and shelling status; and identify a selected delivery location of the plurality of delivery locations for each shrimp having the first physical characteristic passing through the first receiver based at least in part on the first physical characteristic.

In one or more embodiments of a sorting system as described herein, the controller is configured to operate the first slide actuator to rotate the first slide about the first slide axis such that the first slide end is positioned above the selected delivery location such that each shrimp having the first physical characteristic passing through the first receiver is delivered to the selected delivery location after passing along the first slide end exiting the first slide at the first slide end when the first slide end is positioned above the selected delivery location.

In one or more embodiments of a sorting system as described herein, the controller is configured to: receive a signal indicative of the first physical characteristic of each shrimp passing through the second receiver; and identify a second selected delivery location of the plurality of delivery locations for each shrimp having the first physical characteristic passing through the second receiver based at least in part on the first physical characteristic of each shrimp passing through the second receiver.

In one or more embodiments of a sorting system as described herein, the controller is configured to operate the second slide actuator to rotate the second slide about the second slide axis such that the second slide end is positioned above the second selected delivery location such that each shrimp having the first physical characteristic passing through the second receiver is delivered to the second selected delivery location after passing along the second slide end exiting the second slide at the second slide end when the second slide end is positioned above the second selected delivery location.

In one or more embodiments of a sorting system as described herein, the selected delivery location and the second selected delivery location are the same delivery location of the plurality of delivery locations when the first physical characteristic of shrimp passing through the first receiver and the first physical characteristic of shrimp passing through the second receiver are the same.

In one or more embodiments of a sorting system as described herein, the selected delivery location and the second selected delivery location are different delivery locations of the plurality of delivery locations when the first physical characteristic of shrimp passing through the first receiver and the first physical characteristic of shrimp passing through the second receiver are different.

In one or more embodiments of a sorting system as described herein, the system comprises a plurality of guide chutes located between the first arc and the plurality of delivery locations, wherein the plurality of guide chutes are also located between the second arc and the plurality of delivery locations, wherein each guide chute of the plurality of guide chutes comprises an upper end and a lower end, wherein shrimp entering each guide chute of the plurality of guide chutes through the upper end of the guide chute pass through the guide chute and exit the guide chute through the lower end of the guide chute, wherein movement of the first slide end along the first arc moves the first slide end above the upper ends of the plurality of guide chutes, and wherein movement of the second slide end along the second arc moves the second slide end above the upper ends of the plurality of guide chutes.

In one or more embodiments of a sorting system including guide chutes as described herein, each guide chute of the plurality of guide chutes is configured to deliver shrimp passing through the guide chute to only one selected delivery location of the plurality of delivery locations.

In one or more embodiments of a sorting system including guide chutes as described herein, a selected guide chute of the plurality of guide chutes comprises a ramp, wherein shrimp delivered to the selected guide chute by the first slide move both laterally/horizontally and vertically along the ramp under the force of gravity towards the lower end of the selected guide chute, wherein shrimp delivered to the selected guide chute by the second slide move vertically under the force of gravity towards the lower end of the selected guide chute, and wherein shrimp delivered to the selected guide chute from both the first slide and the second slide are delivered to the same selected delivery location located directly beneath the lower end of the selected guide chute. In one or more embodiments, shrimp delivered to the selected guide chute by the second slide move only vertically under the force of gravity towards the lower end of the selected guide chute.

In one or more embodiments of a sorting system including guide chutes as described herein, a second selected guide chute of the plurality of guide chutes comprises a ramp, wherein shrimp delivered to the second selected guide chute by the second slide move both laterally/horizontally and vertically along the ramp under the force of gravity towards the lower end of the second selected guide chute, wherein shrimp delivered to the second selected guide chute by the first slide move vertically under the force of gravity towards the lower end of the selected guide chute, and wherein shrimp delivered to the second selected guide chute from both the first slide and the second slide are delivered to the same second selected delivery location located directly beneath the lower end of the second selected guide chute.

In one or more embodiments of a sorting system as described herein, the system comprises a container positioned at each delivery location of the plurality of delivery locations.

In a second aspect, the present invention includes methods of sorting shrimp using the shrimp sorting systems described herein.

In a third aspect, one or more embodiments of the methods of sorting shrimp as described herein may include: determining a physical characteristic of a first shrimp; identifying a first selected delivery location of a plurality of delivery locations based at least in part on the physical characteristic of the first shrimp; rotating a first slide about a first slide axis such that a first slide end of the first slide is positioned to deliver the first shrimp to the first selected delivery location; delivering the first shrimp to a first tray of the first slide, wherein the first shrimp moves along the first slide from the first tray to the first slide end for delivery to the first selected delivery location under the force of gravity; determining a physical characteristic of a second shrimp, identifying a second selected delivery location of the plurality of delivery locations based at least in part on the physical characteristic of the second shrimp; rotating a second slide about a second slide axis such that a second slide end of the second slide is positioned to deliver the second shrimp to the second selected delivery location; and delivering the second shrimp to a second tray of the second slide, wherein the second shrimp moves along the second slide from the second tray to the second slide end for delivery to the second selected delivery location under the force of gravity.

In one or more embodiments of methods of sorting shrimp as described herein, the method comprises rotating the first slide about the first slide axis to deliver the first shrimp to the first selected delivery location before delivering the first shrimp to the first tray of the first slide.

In one or more embodiments of methods of sorting shrimp as described herein, the first selected delivery location and the second selected delivery location are the same delivery location when the physical characteristic of the first shrimp is the same as the physical characteristic of the second shrimp.

In one or more embodiments of methods of sorting shrimp as described herein, the method comprises guiding the first shrimp to the first selected delivery location using a guide chute that moves the first shrimp laterally with respect to the direction of gravity after the first shrimp leaves the first slide end before the first shrimp reaches the first selected delivery station.

In one or more embodiments of methods of sorting shrimp as described herein, rotating the first slide about the first slide axis moves the first slide end along a first arc and rotating the second slide about the second slide axis moves the second slide end along a second arc, wherein the first arc and the second arc do not intersect.

In one or more embodiments of methods of sorting shrimp as described herein, the first slide axis and the second slide axis are aligned with each other and/or wherein the first slide axis and the second slide axis are oriented generally vertically.

In one or more embodiments of methods of sorting shrimp as described herein, the first slide comprises a first tray configured to receive shrimp and a first guide extending from the first tray to the first slide end located below the first tray, wherein the first slide axis extends through the first tray, wherein the second slide comprises a second tray configured to receive shrimp and a second guide extending from the second tray to the second slide end located below the second tray, and wherein the second slide axis extends through the second tray In one or more embodiments of methods of sorting shrimp as described herein, the physical characteristic of the first shrimp is one of: a selected weight range, a selected length range, heading status, and shelling status.

In one or more embodiments of methods of sorting shrimp as described herein, the physical characteristic of the second shrimp is one of: a selected weight range, a selected length range, heading status, and shelling status.

In a fourth aspect, one or more embodiments of a delivery and sorting system as described herein may include: a plurality of channels, wherein each channel of the plurality of channels comprises a plurality of clamps arranged along a channel axis extending through an unloading location; a channel actuator configured to advance the plurality of channels along the channel axes such that the plurality of clamps move along the channel axes to the unloading location; a plurality of unloaders at the unloading location, wherein each unloader of the plurality of unloaders is configured to remove shrimp from the clamps in one channel of the plurality of channels at the unloading location; a first receiver defining a first passageway extending from a first receiving end to a first transfer end, wherein the first receiver is configured to receive shrimp removed from the clamps in a first channel of the plurality of channels at the unloading location; a second receiver defining a second passageway extending from a second receiving end to a second transfer end, wherein the second receiver is configured to receive shrimp removed from the clamps in a second channel of the plurality of channels at the unloading location; a first slide comprising a first tray located below the first transfer end, the first tray configured to receive shrimp passing through the first receiver from the first receiving end to the first transfer end, wherein the first slide further comprises a first guide extending from the first tray to a first slide end located below the first tray; a second slide comprising a second tray located below the second transfer end, the second tray configured to receive shrimp passing through the second receiver from the second receiving end to the second transfer end, wherein the second slide further comprises a second guide extending from the second tray to a second slide end located below the second tray; a first slide actuator operably connected to the first slide end configured to rotate the first slide about a first slide axis, wherein rotation of the first slide about the first slide axis moves the first slide end along a first arc about the first slide axis; a second slide actuator operably connected to the second slide end configured to rotate the second slide about a second slide axis, wherein rotation of the second slide about the second slide axis moves the second slide end along a second arc about the second slide axis; a plurality of delivery locations located below the first slide and the second slide, wherein movement of the first slide end along the first arc moves the first slide end above the plurality of delivery locations and movement of the second slide end along the second arc moves the second slide end above the plurality of delivery locations; and a controller operably coupled to the plurality of unloaders, the first slide actuator, and the second slide actuator. The controller is configured to: operate the channel actuator to advance the plurality of channels along the channel axes; operate the plurality of unloaders to remove shrimp from the plurality of clamps at the unloading location; operate the first slide actuator to rotate the first slide about the first slide axis such that the first slide end is positioned above a first delivery location of the plurality of delivery locations; operate the second slide actuator to rotate the second slide about the second slide axis such that the second slide end is positioned above a second delivery location of the plurality of delivery locations; and operate the first slide actuator to rotate the first slide about the first slide axis such that the first slide end is positioned above the second delivery location after operating the first slide actuator to rotate the first slide about the first slide axis such that the first slide end is positioned above the second delivery location.

In one or more embodiments of a delivery and sorting system as described herein, the controller is configured to operate the first slide actuator to rotate the first slide about the first slide axis such that the first slide end is positioned above a third delivery location of the plurality of delivery locations such that each shrimp passing through the first receiver is delivered to the third delivery location after passing along the first slide and exiting the first slide at the first slide end when the first slide end is positioned above the third delivery location.

In one or more embodiments of a delivery and sorting system as described herein, the controller is configured to operate the second slide actuator to rotate the second slide about the second slide axis such that the second slide end is positioned above the third delivery location such that each shrimp passing through the second receiver is delivered to the third delivery location after passing along the second slide and exiting the second slide at the second slide end when the second slide end is positioned above the third delivery location.

In one or more embodiments of a delivery and sorting system as described herein, the controller is configured to operate the first slide actuator and the second slide actuator such that the first slide end and the second slide end are both positioned above the third delivery location at the same time such that each shrimp passing through the first receiver and each shrimp passing through the second receiver is delivered to the third delivery location when the first slide end and the second slide end are both positioned above the third delivery location In one or more embodiments of a delivery and sorting system as described herein, the first slide and the first arc are configured to position the first slide end above any selected delivery location of the plurality of delivery locations, and optionally, wherein the second slide and the second arc are configured to position the second slide end above any selected delivery location of the plurality of delivery locations.

In one or more embodiments of a delivery and sorting system as described herein, the controller is configured to: receive a signal indicative of a first physical characteristic of each shrimp passing through the first receiver, wherein, optionally, the first physical characteristic is one of: a selected weight range, a selected length range, heading status, and shelling status; and identify a selected delivery location of the plurality of delivery locations for each shrimp having the first physical characteristic passing through the first receiver based at least in part on the first physical characteristic.

In one or more embodiments of a delivery and sorting system as described herein, the controller is configured to operate the first slide actuator to rotate the first slide about the first slide axis such that the first slide end is positioned above the selected delivery location such that each shrimp having the first physical characteristic passing through the first receiver is delivered to the selected delivery location after passing along the first slide end exiting the first slide at the first slide end when the first slide end is positioned above the selected delivery location.

In one or more embodiments of a delivery and sorting system as described herein, the controller is configured to: receive a signal indicative of the first physical characteristic of each shrimp passing through the second receiver; and identify a second selected delivery location of the plurality of delivery locations for each shrimp having the first physical characteristic passing through the second receiver based at least in part on the first physical characteristic of each shrimp passing through the second receiver.

In one or more embodiments of a delivery and sorting system as described herein, the controller is configured to operate the second slide actuator to rotate the second slide about the second slide axis such that the second slide end is positioned above the second selected delivery location such that each shrimp having the first physical characteristic passing through the second receiver is delivered to the second selected delivery location after passing along the second slide end exiting the second slide at the second slide end when the second slide end is positioned above the second selected delivery location.

In one or more embodiments of a delivery and sorting system as described herein, the selected delivery location and the second selected delivery location are the same delivery location of the plurality of delivery locations when the first physical characteristic of shrimp passing through the first receiver and the first physical characteristic of shrimp passing through the second receiver are the same.

In one or more embodiments of a delivery and sorting system as described herein, the selected delivery location and the second selected delivery location are different delivery locations of the plurality of delivery locations when the first physical characteristic of shrimp passing through the first receiver and the first physical characteristic of shrimp passing through the second receiver are different.

In one or more embodiments of a delivery and sorting system as described herein, the system comprises a plurality of guide chutes located between the first arc and the plurality of delivery locations, wherein the plurality of guide chutes are also located between the second arc and the plurality of delivery locations, wherein each guide chute of the plurality of guide chutes comprises an upper end and a lower end, wherein shrimp entering each guide chute of the plurality of guide chutes through the upper end of the guide chute pass through the guide chute and exit the guide chute through the lower end of the guide chute, wherein movement of the first slide end along the first arc moves the first slide end above the upper ends of the plurality of guide chutes, and wherein movement of the second slide end along the second arc moves the second slide end above the upper ends of the plurality of guide chutes.

In one or more embodiments of a delivery and sorting system as described herein, each guide chute of the plurality of guide chutes is configured to deliver shrimp passing through the guide chute to only one selected delivery location of the plurality of delivery locations.

In one or more embodiments of a delivery and sorting system as described herein, a selected guide chute of the plurality of guide chutes comprises a ramp, wherein shrimp delivered to the selected guide chute by the first slide move both laterally/horizontally and vertically along the ramp under the force of gravity towards the lower end of the selected guide chute, wherein shrimp delivered to the selected guide chute by the second slide move vertically under the force of gravity towards the lower end of the selected guide chute, and wherein shrimp delivered to the selected guide chute from both the first slide and the second slide are delivered to the same selected delivery location located directly beneath the lower end of the selected guide chute.

In one or more embodiments of a delivery and sorting system as described herein, shrimp delivered to the selected guide chute by the second slide move only vertically under the force of gravity towards the lower end of the selected guide chute.

In one or more embodiments of a delivery and sorting system as described herein, a second selected guide chute of the plurality of guide chutes comprises a ramp, wherein shrimp delivered to the second selected guide chute by the second slide move both laterally/horizontally and vertically along the ramp under the force of gravity towards the lower end of the second selected guide chute, wherein shrimp delivered to the second selected guide chute by the first slide move vertically under the force of gravity towards the lower end of the selected guide chute, and wherein shrimp delivered to the second selected guide chute from both the first slide and the second slide are delivered to the same second selected delivery location located directly beneath the lower end of the second selected guide chute.

In one or more embodiments of a delivery and sorting system as described herein, the system comprises a container positioned at each delivery location of the plurality of delivery locations.

In a fifth aspect, the present invention includes methods of delivering and sorting shrimp using the shrimp delivery and sorting systems described herein.

As used herein, the term “shrimp” should be construed to refer to crustaceans harvested for human consumption that are referred to as either shrimp or prawns in the sub-orders Pieocyemata (Shrimp) and Dendrobranchiata (Prawns). Further, because the physical characteristics of shrimp capable of being sorted using the shrimp sorting systems and methods described herein can vary widely, any dimensions discussed herein are provided only as a general guide and further refinement of any such dimensions may be required to optimize operation of the shrimp sorting systems and methods described herein based on for example, the size, species, and/or general conditions of shrimp being processed.

If used herein, relational terms such as above, below, top, bottom, etc. are (unless otherwise specified in this description and/or the claims) used only to facilitate description of the various features of the shrimp sorting systems and methods described herein and should not be construed to require any specific orientation of the shrimp sorting systems and/or the methods described herein unless otherwise specified (e.g., where gravitational force is required and/or used to effect a desired result).

When used herein, the term “aligned with” as used in connection with various components, axes, directions of travel, etc. includes both parallel and generally parallel arrangements. For example, two axes (or other components, features, etc.) may be described as “aligned with” when the axes (or other components, features, etc.) are both perfectly parallel with each other or nearly parallel, e.g., the axes (or other components, features, etc.) may form an angle with each other that is greater than 0° but 10° or less.

If used herein, the term “substantially” has the same meaning as “significantly,” and can be understood to modify the term that follows by at least about 75%, at least about 90%, at least about 95%, or at least about 98%. The term “not substantially” as used herein has the same meaning as “not significantly,” and can be understood to have the inverse meaning of “substantially,” i.e., modifying the term that follows by not more than 25%, not more than 10%, not more than 5%, or not more than 2%.

Numeric values used herein include normal variations in measurements as expected by persons skilled in the art and should be understood to have the same meaning as “approximately”and to cover a typical margin of error, such as ±5 % of the stated value.

Terms such as “a,” “an,” and “the” are not intended to refer to only a singular entity but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

The above summary of the invention is not intended to describe each embodiment or every implementation of the shrimp sorting systems and methods described herein. Rather, a more complete understanding of the invention will become apparent and appreciated by reference to the following description of illustrative embodiments and claims in view of the accompanying figures of the drawing.

### BRIEF DESCRIPTION OF THE DRAWING

FIG. 1 is a front perspective view of one illustrative embodiment of a sorting system as described herein.

FIG. 2 is a rear perspective view of the sorting system of FIG. 1.

FIG. 3 is a side view of the sorting system of FIGS. 1-2 with the frame and other components removed for clarity.

FIG. 4 is a perspective view of the receivers in the sorting system of FIGS. 1-2.

FIG. 5 is a top view of the slides and guide chutes of the sorting system depicted in FIGS. 1-4.

FIG. 6 is a side view of the slides and guide chutes as depicted in FIG. 5.

FIG. 7 is a bottom view of the slides and guide chutes as depicted in FIGS. 5-6.

FIG. 8 is a top perspective view of one isolated guide chute of the guide chutes depicted in FIGS. 5-7.

FIG. 9 is a bottom perspective view of the guide chute depicted in FIG. 8.

FIG. 10 is a side view of the guide chute depicted in FIGS. 8-9.

FIG. 11 is a perspective view of one illustrative embodiment of an array of containers located at a set of delivery locations for the guide chutes of the sorting systems described herein.

FIG. 12 is a top view of the containers of FIG. 11.

FIG. 13 is a top view of the sorting system of FIG. 1 along with one illustrative embodiment of a set of channels used to deliver shrimp to the sorting system for sorting as described herein.

FIG. 14 is a perspective view of one illustrative embodiment of a set of unloaders and clamps along with channels used in one illustrative embodiment of a delivery apparatus to deliver the clamps to a sorting system as described herein.

FIG. 15 is a side view of the components depicted in FIG. 14 after ejection/unloading of a shrimp from a clamp as described herein.

FIG. 16 is a schematic block diagram of components that may be found in one or more embodiments of the sorting systems as described herein.

While the above-identified figures (which may or may not be drawn to scale) set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope of this invention.

### DESCRIPTION OF ILLUSTRATIVE EMBODIMENTS

In the following description, reference is made to the accompanying figures of the drawing which form a part hereof, and in which are shown, by way of illustration, specific embodiments. It is to be understood that other embodiments may be utilized and changes may be made without departing from the scope of the present invention.

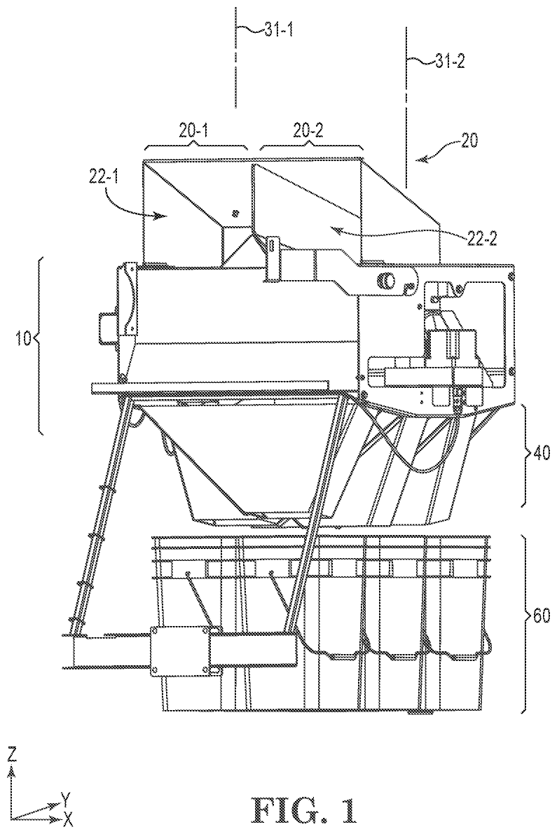

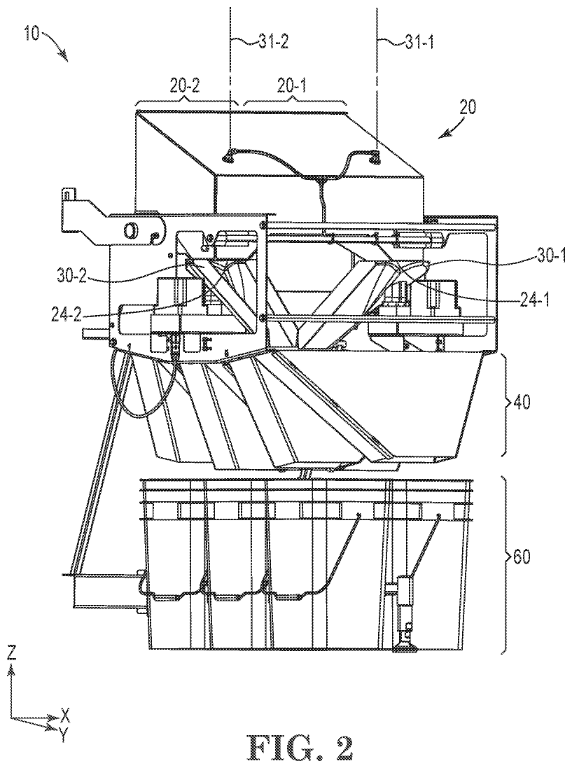

One illustrative embodiment of a sorting system as described herein is depicted in various views in FIGS. 1-2 in which FIG. 1 is a front perspective view of the depicted embodiment of sorting system 10 and FIG. 2 is a rear view of the sorting system 10.

The depicted illustrative embodiment of sorting system 10 includes first receiver 20-1 and second receiver 20-2 (which may be collectively referred to herein as receivers 20). The first receiver 20-1 and second receiver 20-2 are supported on a frame above a set of guide chutes 40. A set of containers 60 are arranged below the set of guide chutes 40. In one or more embodiments, shrimp may be, as described herein, selectively delivered into the containers 60 based on one or more physical characteristics including, but not limited to size, heading status, peeling status, deveining status, etc.

Each of the receivers 20 defines a passageway extending from a receiving end to a transfer end. In particular, receiver 20-1 extends from a receiving end 22-1 to a transfer end 24-1 while receiver 20-2 extends from a receiving end 22-2 to a transfer end 24-2. Shrimp introduced into each of the receivers 20 through the receiving end travels along the passageway to the transfer end. In particular, shrimp introduced into the receiving end 22-1 of receiver 20-1 travel along the passageway defined by receiver 20-1 to the transfer end 24-1 where the shrimp exit the receiver 20-1. Similarly, shrimp introduced into the receiving end 22-2 of receiver 20-2 travel along the passageway defined by receiver 20-2 to the transfer end 24-2 where the shrimp exit the receiver 20-2.

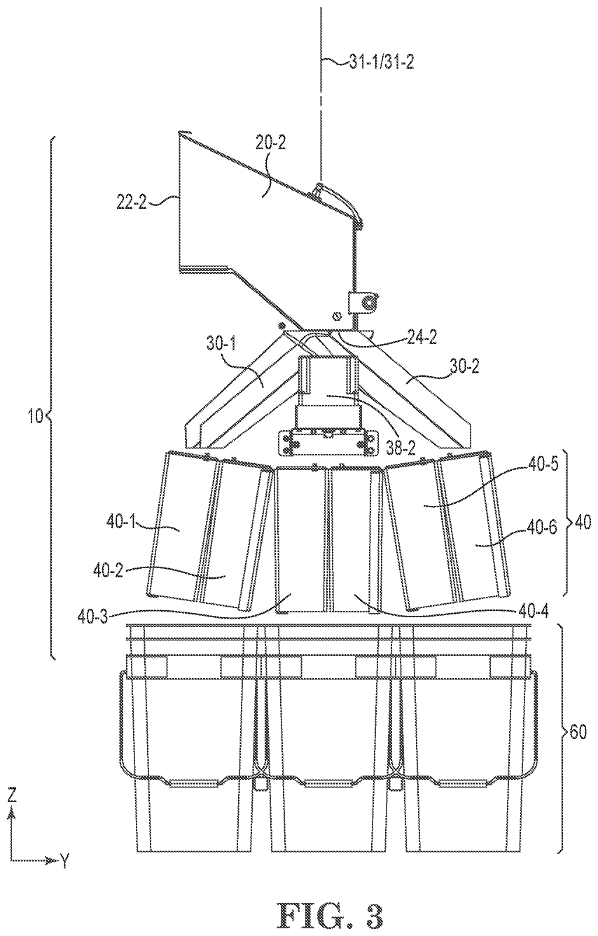

FIG. 3 is a side view of the sorting system 10 of FIGS. 1-2 with the frame and other components removed for clarity. As seen in FIG. 3, the sorting system 10 includes a pair of slides 30-1 and 30-2 (collectively preferred to as slides 30 herein) located between the set of guide chutes 40 and the receivers 20. Slides 30 rotate above the optional set of guide chutes 40 to distribute each shrimp delivered to the slides to a selected guide chute in the set of guide chutes 40. In particular, slide 30-1 rotates about slide axis 31-1 while slide 30-2 rotates about slide axis 31-2.

Also with reference to FIG. 3, each guide chute of the optional set of guide chutes 40 is separately numbered with the set of guide chutes 40 including guide chutes 40-1, 40-2, 40-3, 40-4, 40-5, and 40-6. Each of the slides 30 rotates such that shrimp delivered to each slide 30 can be delivered to any one of the guide chutes 40 and subsequently delivered to a selected delivery location defined by each container of the set of containers 60.

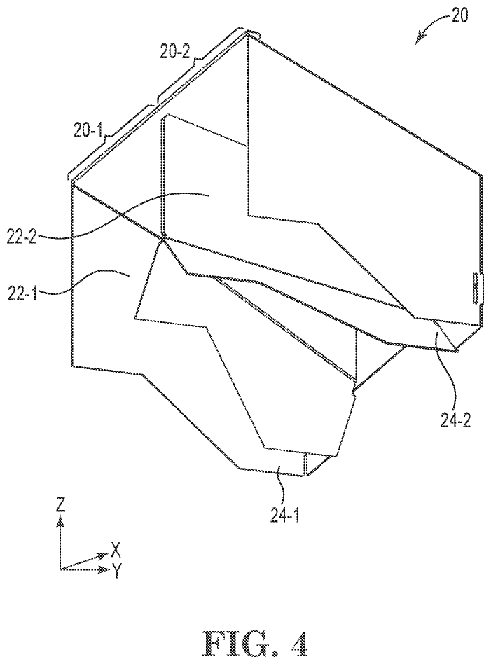

FIG. 4 is an isolated perspective view of the pair of receivers 20 used in the system depicted in FIGS. 1-3. As depicted in FIG. 4 and described herein, receiver 20-1 includes a passageway extending between a receiving end 22-1 and a transfer end 24-1 while receiver 20-2 includes a passageway extending between a receiving end 22-2 and a transfer end 24-2. Shrimp delivered into the receiving end 22-1 of receiver 20-1 move along the passageway within receiver 20-1 to the transfer end 24-1 where the shrimp exit the receiver 20-1 and are deposited on slide 30-1. Shrimp delivered into the receiving end 22-2 of receiver 20-2 move along the passageway within receiver 20-2 to the transfer end 24-2 where the shrimp exit the receiver 20-2 and are deposited on slide 30-2.

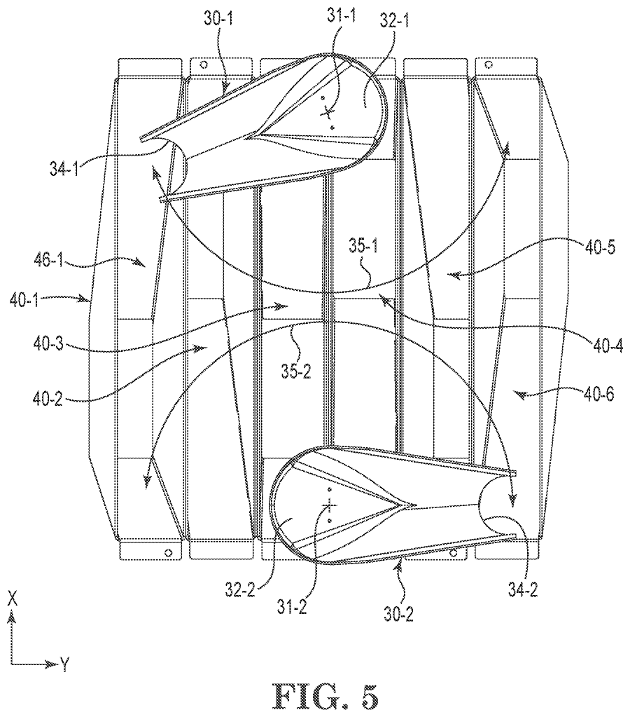

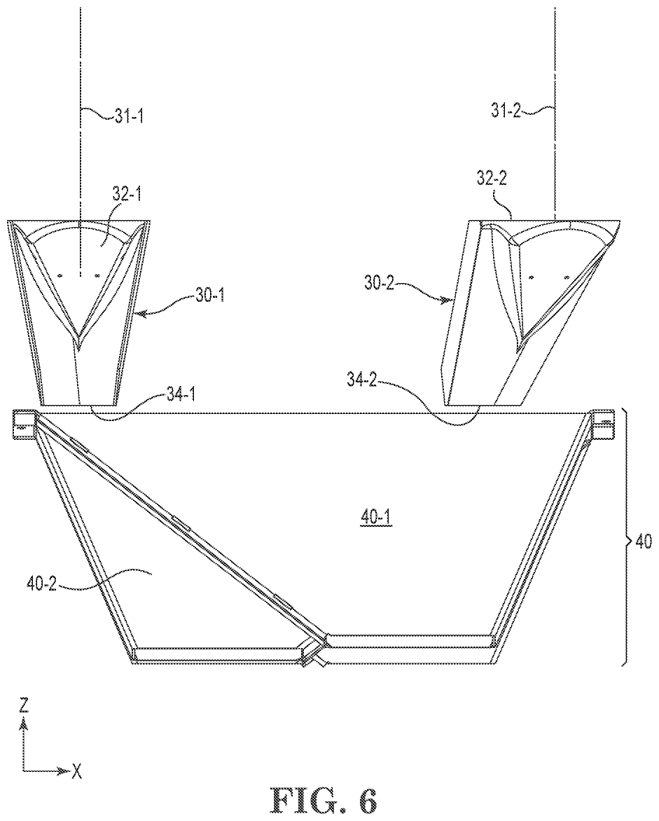

FIGS. 5-7 depict only the slides 30 and optional guide chutes 40 for clarity in describing the movement of shrimp along the slides 30 and through the guide chutes 40. With reference to FIGS. 5-6, slide 30-1 extends between a tray 32-1 and a slide end 34-1 with the slide end 34-1 being located below the tray 32-1 such that a shrimp deposited on the tray 32-1 of slide 30-1 typically moves along the slide 30-1 to the slide end 34-1 where the shrimp exits the slide 30-1. Similarly, slide 30-2 extends between a tray 32-2 and a slide end 34-2 with the slide end 34-tubing located below the tray 32-2 such that a shrimp deposited on the tray 32-2 of slide 30-2 typically moves along the slide 30-2 to the slide end 34-2 where the shrimp exits the slide 30-2.

Shrimp are deposited on the trays 32-1/32-2 from the transfer ends 24-1/24-2 of the receivers 20 as described herein. Movement of shrimp along the slide 30-1/30-2 under the force of gravity may be influenced by a variety of factors including the surface and materials of the slide 30-1/30-2, the angle or vertical drop from the tray 32-1/32-2 to the slide end 34-1/34-2, the presence of any lubricants (e.g., water, etc.), etc.

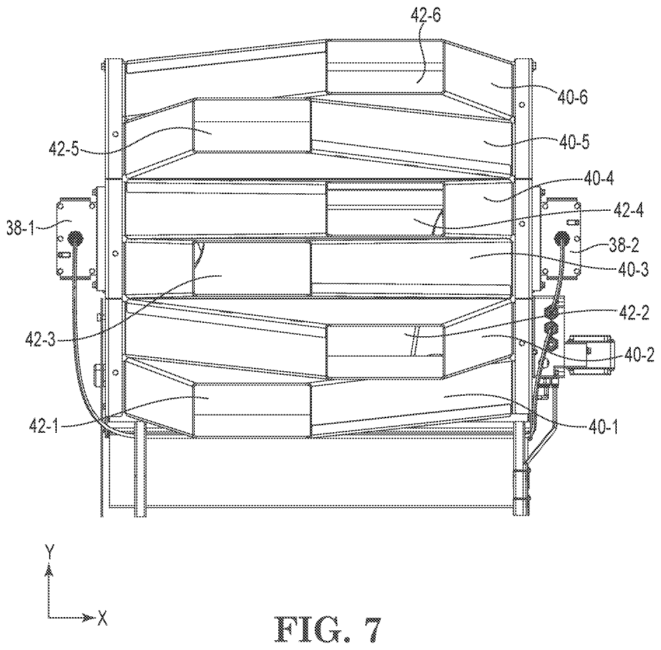

The optional set of guide chutes 40 include, as described herein, chutes 40-1, 40-2, 40-3, 40-4, 40-5, and 40-6 arranged along the Y axis as seen in FIGS. 5 and 7. Rotation of the slides about their respective slide axes as described herein is used to direct shrimp delivered to the trays of each slide to a selected guide chute. With reference to FIG. 5, slide 30-1 is configured to rotate about slide axis 31-1 with rotation of slide 30-1 about slide axis 31-1 moving the slide end 34-1 along an arc 35-1 centered about the slide axis 31-1. Arc 35-1 extends over all of the guide chutes 40 such that rotation of the slide 30-1 about slide axis 31-1 can be used to position the slide end 34-1 over any selected guide chute 40. As a result, shrimp deposited on tray 32-1 of the slide 30-1 can be delivered to any one of the guide chutes 40 based on the position of the slide end 34-1.

Similarly, slide 30-2 is configured to rotate about slide axis 31-2 with rotation of slide 30-2 about slide axis 31-2 moving the slide end 34-2 along an arc 35-2 centered about slide axis 31-2. Arc 35-2 extends over all of the guide chutes 40 such that rotation of the slide 30-2 about slide axis 31-2 can be used to position the slide end 34-2 over any selected guide chute 40. As a result, shrimp deposited on tray 32-2 of the slide 30-2 can be delivered to any one of the guide chutes 40 based on the position of the slide end 34-2.

In one or more embodiments, the arcs 35-1 and 35-2 followed by the slide ends 34-1 and 34-2 of slides 30-1 and 30-2 do not intersect such that the slide ends 34 have been one and 34-2 do not interfere or collide with each other during rotation of the slides 30 about their respective axes.

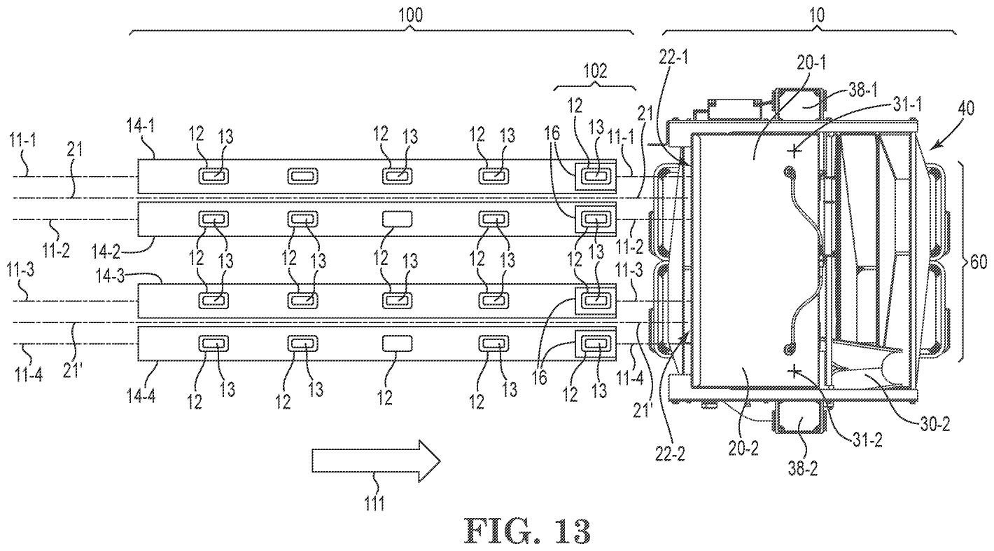

With reference to FIG. 7 (which includes a portion of the frame supporting the components of the sorting system) (see also, FIG. 13) along with FIGS. 3 and 5-6, the slide actuators used to rotate the slides 30 about their respective axes are depicted. In particular, actuator 38-1 is operably connected to slide 30-1 to rotate slide 30-1 about slide axis 31-1, while actuator 38-2 is operably connected to slide 30-2 to rotate slide 30-2 about slide axis 31-2. The actuators 38-1/38-2 may be provided in any suitable form, e.g., air motors, electric motors, hydraulic motors, solenoids, pistons, etc. that are either directly connected to the slides or operably connected to the slides 30-1/30-2 through any suitable mechanism, e.g., gears, belts, etc. As used herein, the term “actuator” (and variations thereof) refers to any combination of a drive unit and transfer assembly used to effect rotation of the slides about their respective axes.

In one or more embodiments, the slide axis 31-1 can be described as passing through the tray 32-1 of slide 30-1 and, optionally, the slide axis 31-2 can be described as passing through the tray 32-2 of slide 30-2. In one or more embodiments, the slide axes 31-1 and 31-2 may be aligned with each other. In one or more embodiments, the slide axes 31-1 and 31-2 may be described as being oriented generally vertically (with respect to the direction of gravitational forces acting on shrimp passing through the sorting system). Although the slide axes 31-1 and 31-2 may be oriented vertically in one or more embodiments (to, e.g., maximize the gravitational forces moving shrimp along the slides 30), the slide axes may not be oriented vertically in one or more alternative embodiments of sorting systems as described herein.

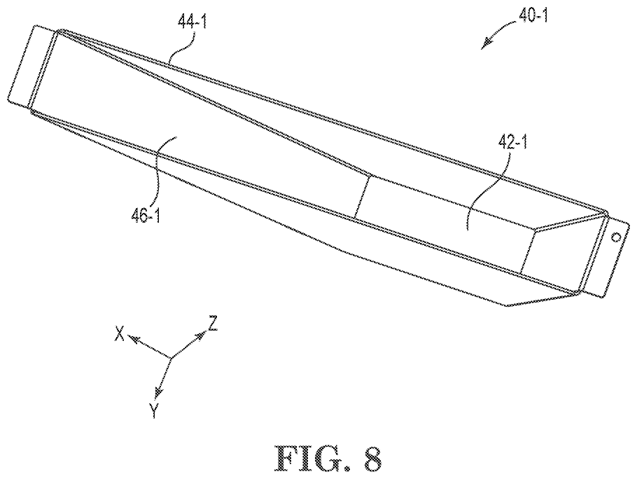

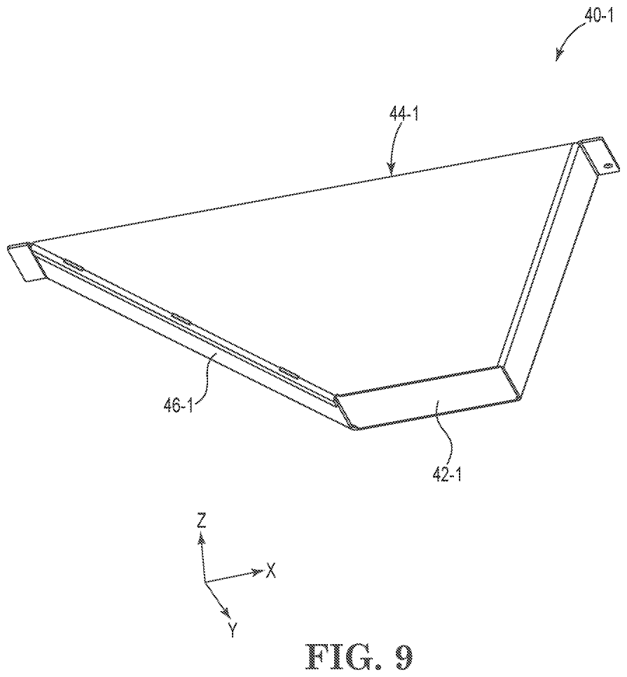

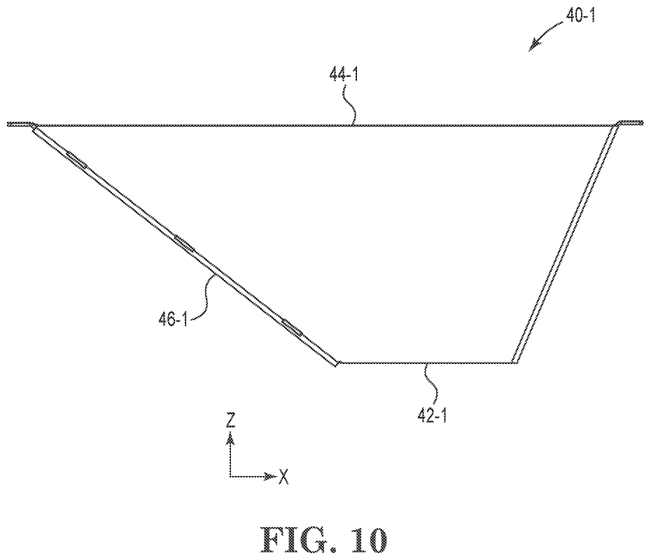

FIGS. 8-10 depict guide chute 40-1 isolated from the optional set of guide chutes 40 to describe features that are common to all of the guide chutes in the depicted sorting system. Guide chute 40-1 includes a lower end 42-1 and an upper end 44-1. Shrimp entering guide chute 40-1 through upper end 44-1 pass through the guide chute 40-1 and exit the guide chute through the lower end 42-1. The opening provided in lower end 42-1 of guide chute 40-1 is sized such that shrimp passing through the guide chute 40-1 enter only one selected container 60 at a selected delivery location beneath the set of guide chutes 40.

Because slides 30-1 and 30-2 both deliver shrimp into the opening at the upper end 44-1 of the guide chute 40-1 and the ends 34-1 and 34-2 do not interfere with each other, the opening at the upper and 44-1 must be large enough to receive shrimp from both of the slides 30 in the depicted sorting system. In the depicted embodiment, slide end 34-2 of slide 30-2 is directly over both the opening in the upper end 44-1 and the opening in the lower end 42-1 of guide chute 40-1 when positioned at the left end of its arc 35-2 (see, e.g., FIG. 5) such that a shrimp exiting slide 30-2 may drop directly into the container 60 located beneath the opening in lower end 42-1 of guide chute 40-1.

In contrast, while slide end 34-1 of slide 30-1 is directly over the opening in the upper end 44-1 of guide chute 40-1 when slide 30-1 is positioned at the left end of its arc 35-2 (see, e.g., FIG. 5), slide end 34-1 of slide 30-1 is not directly over the opening in the lower end 42-1 of guide chute 40-1. As a result, a shrimp exiting slide 30-2 may drop directly into the guide chute 40-1 but will travel along ramp 46-1 of guide chute 40-1 until the shrimp reaches the opening in the lower end 42-1 of guide chute 40-1 where the shrimp drops into the container 60 located beneath the opening in the lower and 42-1 of guide chute 40-1.

Ramp 46-1 of guide chute 40-1, as well as similar ramps found in each of the guide chutes 40-2, 40-3, 40-4, 40-5, and 40-6 can be described as guiding or moving shrimp in a lateral or horizontal direction with respect to the direction of gravity after the shrimp leaves the slide end before the shrimp reaches the selected delivery station (e.g., aligned with the X axis in the Cartesian coordinate systems noted in the figures).

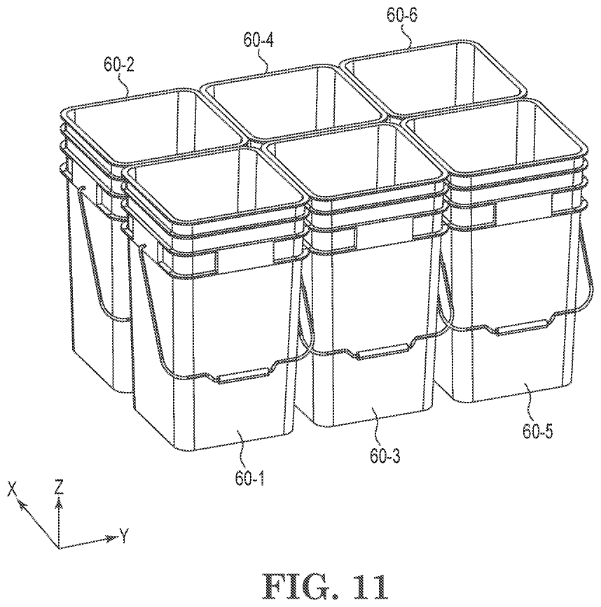

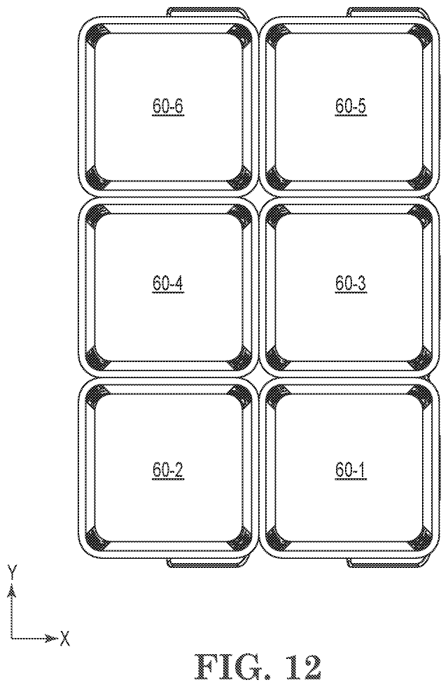

FIGS. 11-12 depict one illustrative set of delivery locations that may be used to receive shrimp passing through the sorting systems including guide chutes as described herein. In the depicted set of delivery locations 60-1, 60-2, 60-3, 60-4, 60-5, and 60-6 (which will be collectively referred to as delivery locations 60), each of the delivery locations 60 is occupied or defined by a bucket-like container in which the opening of each container defines one of the delivery locations 60 to which the guide chutes 40 of the sorting system are configured to deliver shrimp passing through the guide chutes 40.

The optional guide chutes provide a number of advantages. In one or more embodiments, the guide chutes 40 allow for separation/sorting and delivery of shrimp into delivery locations or groups. Although the depicted embodiment includes six different guide chutes (one for each of the six delivery locations in the depicted embodiment of a sorting system), one or more alternative sorting systems may include a set of guide chutes configured to deliver/separate/sort shrimp into as few as two delivery locations/groups, three delivery locations/groups, four delivery locations/groups, five delivery locations/groups, or more than six delivery locations/groups.

In the absence of the optional guide chutes 40, each of the slides 30 may be configured to deliver shrimp to as few as two different delivery locations or any other selected number of delivery locations (limited by, of course, physical size constraints based on the length of the arcs travelled by the slide ends, the size of the shrimp being delivered, etc.).

In one or more embodiments, the shrimp delivered to each delivery location/container 60 may be delivered to each delivery location/container 60 based on one or more physical characteristics associated with the shrimp. For example, each delivery location/container 60 may receive shrimp within different size ranges (based on actual measured or derived weight, length, girth, etc.). Other physical characteristics of shrimp that may be used to determine to which delivery location/container each shrimp should be delivered may include heading status (e.g., head on or head off), deveining status (e.g., mud vein removed or not), peeling status (shells and/or pleopods/swimmerets removed or not), etc.

In one or more embodiments of a shrimp sorting system as described herein, a combination of physical features may be used to determine which delivery location/container 60 shrimp are to be delivered. For example, shrimp within the same size range but having different heading, deveining, and/or peeling status may be delivered to different delivery locations/containers 60.

Although the delivery locations 60 are defined by containers in the depicted embodiment, one or more alternative embodiments may involve delivery locations defined by a landing area of a conveying system configured to convey shrimp away from the delivery location such that operation of the sorting system may be more continuous without requiring removal and replacement of containers as the containers fill with shrimp.

The methods of sorting shrimp as described herein may, in one or more embodiments, include: determining a physical characteristic of a first shrimp (e.g., a selected weight range, a selected length range, heading status, shelling status, etc.); identifying a first selected delivery location (e.g., delivery location 60-1) of a set of delivery locations (e.g., delivery locations 60) based at least in part on the physical characteristic of the first shrimp; rotating a first slide (e.g., slide 30-1), about a first slide axis (e.g., slide axis 31-1), such that a first slide end (e.g., slide end 34-1) of the first slide is positioned to deliver the first shrimp to the first selected delivery location; delivering the first shrimp to a first tray (e.g., tray 32-1) of the first slide, wherein the first shrimp moves along the first slide (e.g., first slide 30-1) from the first tray to the first slide end for delivery to the first selected delivery location (e.g., delivery location 60-1) under the force of gravity.

The method may further include determining a physical characteristic of a second shrimp (e.g., a selected weight range, a selected length range, heading status, shelling status, etc.); identifying a second selected delivery location (e.g., delivery location 60-2) of the plurality of delivery locations based at least in part on the physical characteristic of the second shrimp; rotating a second slide (e.g., slide 30-2) about a second slide axis (e.g., slide axis 31-2) such that a second slide end (e.g., slide end 34-2) of the second slide is positioned to deliver the second shrimp to the second selected delivery location (e.g., delivery location 60-2); and delivering the second shrimp to a second tray (e.g., tray 32-2) of the second slide, wherein the second shrimp moves along the second slide from the second tray to the second slide end for delivery to the second selected delivery location under the force of gravity.

In one or more embodiments of the methods of sorting shrimp described herein, the methods may include rotating the first slide 30-1 about the first slide axis 31-1 to deliver the first shrimp to the first selected delivery location 60-1 before delivering the first shrimp to the first tray 32-1 of the first slide 30-1.

In one or more embodiments of the methods of sorting shrimp described herein, the first selected delivery location and the second selected delivery location of the set of delivery locations 60 are the same delivery location when the physical characteristic of the first shrimp is the same as the physical characteristic of the second shrimp. For example, both the first shrimp and the second shrimp may be delivered to delivery location 60-1 or any other selected delivery location.

In one or more embodiments of the methods of sorting shrimp described herein, the method may include guiding the first shrimp to any selected delivery location using a guide chute that moves the first shrimp laterally with respect to the direction of gravity after the first shrimp leaves the first slide 30-1 and before the first shrimp reaches the selected delivery location.

The sorting systems described herein may be paired with delivery apparatus used to deliver shrimp to be sorted to the sorting systems described herein. One illustrative embodiment of a delivery apparatus that may be used to deliver shrimp to be sorted to the illustrative embodiment of a sorting system as described herein is depicted in FIGS. 13-15.

In the schematic diagram of FIG. 13, the delivery apparatus 100 includes a set of channels 14-1, 14-2, 14-3, 14-4 (collectively referred to as channels 14 herein) which may be in the form of, for example, conveyor belts, tracks, etc. Each of the channels 14 defines a channel axis with channel 14-1 defining channel axis 11-1, channel 14-2 defining channel axis 11-2, channel 14-3 defining channel axis 11-3, and channel 14-4 defining channel axis 11-4 (with the channels collectively referred to as channels 11 herein). The channels 14 are arranged to deliver shrimp to an unloading location 102 proximate the receivers 20-1 and 20-2 of sorting system 10.

Each of the channels 14 includes a set of clamps 12 arranged along its channel axis 11, with the channels 14 being used to deliver the clamps 12 to the delivery location 102 by moving the clamps 12 along the direction of arrow 111. The clamps 12 in the depicted illustrative embodiment of delivery apparatus 100 include shrimp 13 carried by at least some of the clamps 12. As depicted in FIG. 12, some clamps may not carry shrimp (see, e.g., channels 14-2 and 14-4, each of which includes at least one clamp 12 that is not carrying a shrimp 13.

Movement of the channels 14 is accomplished using a channel actuator that is configured to advance each channel 14 along its channel axis such that the clamps 12 in each of the channels 14 move along the channel axes 11 to the unloading location 102. The channel actuator may be in the form of any suitable drive system configured to move each channel and the shrimp carried by each channel in a desired direction including, but not limited to, motors, pistons, air or other fluids, etc.

The depicted illustrative embodiment of delivery apparatus 100 also includes unloaders 16 located within the unloading location 102. The unloaders 16 are configured to remove shrimp 13 from the clamps 12 in each channel 14 at the unloading location 102. In one or more embodiments, the unloaders 16 may be in the form of plungers configured to force a shrimp 13 out of the clamp 12, pick and place equipment configured to remove shrimp 13 from the clamps 12, release mechanisms configured to open the clamps 12 to allow shrimp 13 to fall out of or otherwise disengage from the clamps 12, etc.

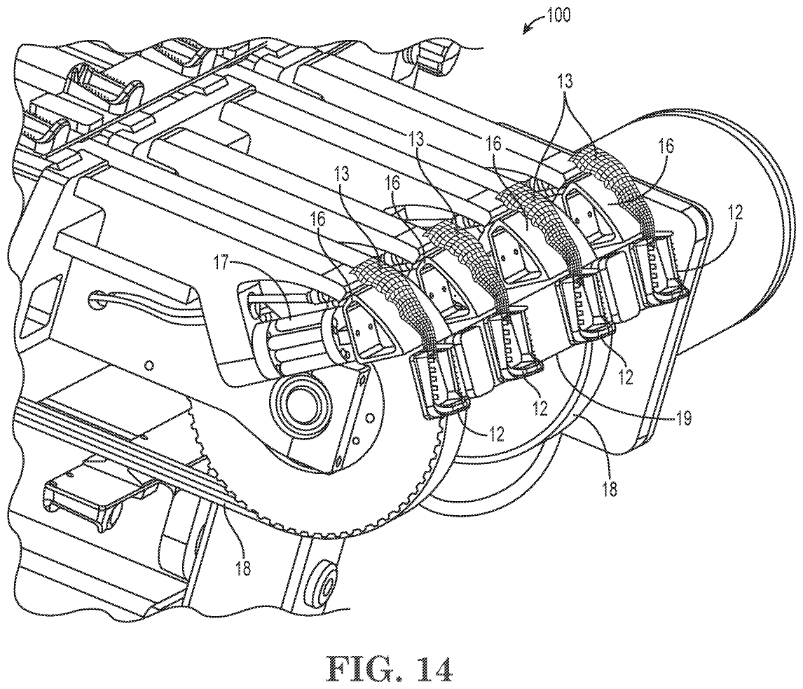

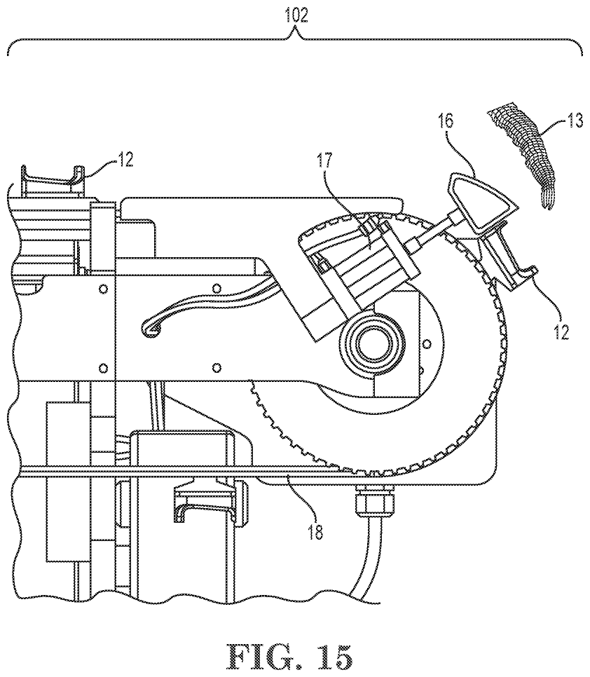

FIGS. 14-15 depict one illustrative embodiment of a set of unloaders 16 in one illustrative embodiment of a delivery apparatus 100, with the unloaders 16 used to eject or remove shrimp 13 from clamps 12. In the depicted embodiment, clamps 12 are carried in sets of four clamps 12 on a clamp mount 19 using conveying elements 18 (as opposed to providing separate conveying elements for each channel, with each clamp 12 carried individually in its own channel).

The unloaders 16 in the depicted illustrative embodiment are provided in the form of plungers configured to force shrimp 13 out of clamps 12 using an actuator 17 (e.g., a piston operated hydraulically, pneumatically, using a solenoid, etc.). The actuator 17 is retracted in FIG. 14 as the shrimp 13 carried in clamps 12 are moved into the delivery location 102 (see FIG. 15).

When the shrimp 13 are in position relative to the unloaders 16, the actuators 17 may be actuated to force the shrimp 13 out of the clamps 12 as depicted in, e.g., FIG. 15. In the depicted illustrative embodiment, the plungers of unloaders 16 may be described as having arcuate surfaces that act on the ventral surfaces of the shrimp 13 to, preferably, reduce or eliminate damage to the shrimp 13 during the unloading/ejection process. Also, in one or more embodiments the unloaders 16 may provide sufficient velocity to the shrimp 13 such that the shrimp 13 are delivered into the receivers 20-1 and 20-2 through their respective receiving ends 22-1 and 22-2.

In one or more embodiments, the unloaders 16 may provide sufficient velocity to the shrimp 13 such that the shrimp 13 enter the receivers 20-1 and 20-2 with sufficient velocity to reach the transfer ends of the receivers 24 delivery to slides 30 as described herein. Movement of shrimp through each of the receivers 20 may be enhanced through the use of one or more lubricants (e.g., water, etc.) delivered (e.g., sprayed, etc.) into each of the receivers 20.

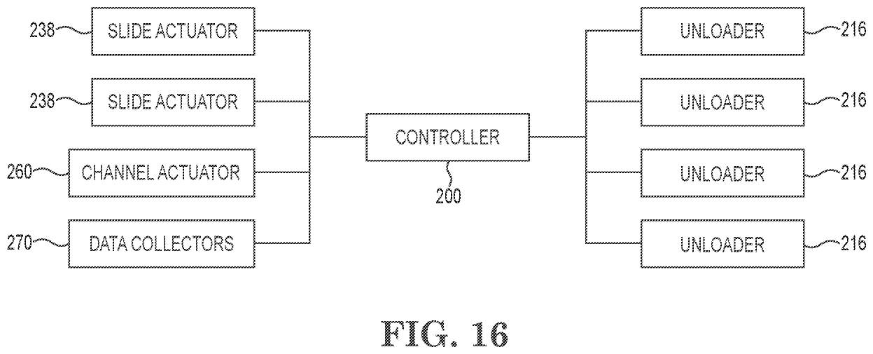

FIG. 16 is a schematic diagram of components in one illustrative embodiment of a sorting system and delivery apparatus that may be used to sort shrimp as described herein.

The depicted system includes a controller 200 operably connected to a pair of slide actuators 238, a channel actuator 260, and data collectors 270. Controller 200 is also operably connected to a set of unloaders 216 which may be used to remove shrimp from clamps or other carriers delivering shrimp to an unloading location as described herein.

The slide actuators 238 are operably connected to the slides of a sorting system as described herein and are configured to, as described herein, rotate the slides about their respective receiving axes.

The channel actuator 260 is operably connected to channels (for example, conveyors, etc.) and used to advance the channels along their respective channel axis as described herein. The unloaders 216 can be used, as described herein, to remove shrimp from clamps at the unloading location such that the shrimp can enter the receivers of the sorting systems described herein for sorting as described herein. With reference to the illustrative embodiment depicted in FIGS. 13-15, the unloaders 16 may include actuators 17 that are operably connected to the controller 200. In one or more embodiments, the actuators 17 of unloaders 16 as depicted in FIGS. 13-15 may be operably connected to a control system used to operate the delivery apparatus 100 and/or components of the sorting systems described herein.

The depicted illustrative embodiment of the system depicted in FIG. 16 includes data collectors 270 that may, in one or more embodiments, be configured to obtain information indicative of at least one physical characteristic of shrimp to be delivered to the delivery locations as described herein. The data collectors 270 may be configured to detect, identify, and/or associate one or more physical characteristics with each shrimp to be sorted. In one or more embodiments, the data collectors 270 may be in the form of in the form of, e.g., sensors (e.g., optical sensors, capacitive sensors, vision systems, mass sensors, etc.). The data collectors 270 may be configured to provide selected information to the controller 200 selected from the group of size (determined by one or more of weight, length, girth, etc.), peeling status, heading status, and deveining status.

Characteristics such as, e.g., peeling status, heading status, and deveining status may be associated with selected shrimp by one or more processing stations located upstream of the unloading location 102, with the processing stations configured to peel, head, and/or devein shrimp and associate those actions/status with specific shrimp in the clamps of the delivery apparatus 100. Illustrative examples of apparatus and systems that may be used to peel, head, and/or devein shrimp and associate those actions/status with specific shrimp in clamps of a delivery apparatus similar to that depicted in FIGS. 13-15 herein may be found in one or more of International Publication No. WO 2021/158894 (SHRIMP PROCESSING SYSTEM, PROCESSING APPARATUS AND METHODS); WO 2021/158892 (SHRIMP PROCESSING SYSTEM, PROCESSING APPARATUS AND METHODS); and WO 2021/158897 (SHRIMP PROCESSING SYSTEM, PROCESSING APPARATUS AND METHODS).

Using the selected information associated with each of the shrimp delivered to the unloading location by the channels of the delivery apparatus as described herein, the controller 200 may be configured to operate a slide actuator 238 to rotate a slide operably connected to the slide actuator 238 about its slide axis such that a slide end of the slide is above a selected guide chute such that shrimp exiting the slide are delivered to a selected delivery location of a set of delivery locations, with the selected delivery location selected based at least in part on the selected physical characteristic provided regarding the shrimp being delivered. After positioning the slide end above a guide chute configured to deliver shrimp to the selected delivery location, the unloader may be operated to remove the shrimp from the selected clamp located at the unloading location, where positioning of the slide includes rotating the slide such that the slide end is located above the guide chute associated with the selected delivery location.

The controller 200 may be provided in any suitable form and may, for example, include memory and a controller. The controller may, for example, be in the form of one or more microprocessors, Field-Programmable Gate Arrays (FPGA), Digital Signal Processors (DSP), microcontrollers, Application Specific Integrated Circuit (ASIC) state machines, etc. The controllers may include one or more of any suitable input devices configured to allow a user to operate the sorting systems and/or delivery end sorting systems described herein (e.g., keyboards, touchscreens, mice, trackballs, etc.), as well as display devices configured to convey information to a user (e.g., monitors (which may or may not be touchscreens), indicator lights, etc.). Although not depicted separately, the controller 200 may incorporate a pneumatic and/or hydraulic control system in those systems in which one or more of the actuators use pneumatic and/or hydraulic components.

With reference to FIGS. 13-14, in one or more embodiments of the sorting systems as described herein, the controller 200 may be configured to operate the channel actuator 260 to advance the channels 14 along their respective channel axes 11.

The controller 200 may further be configured to operate the unloaders 216 to remove shrimp from the clamps 12 at the unloading location 102.

Another feature of one or more embodiments of a delivery and sorting system as described herein is the ability of the systems to selectively deliver shrimp to one or more of the delivery locations arranged beneath the guide chutes described herein. In particular, although a pair of channels 14-1 and 14-2 are arranged to deliver shrimp to the receiver 20-1 while a second pair of channels 14-3 and 14-4 are arranged to deliver shrimp to the receiver 20-2, in many instances the shrimp delivered by each pair of channels to each of the receivers 20 may or may not have the same physical characteristics that would require them to be delivered to the same delivery location as described herein.

For example, the shrimp 13 carried on clamp 12 in channel 14-1 of FIG. 13 may have one or more different physical characteristics from the shrimp 13 carried on clamp 12 of channel 14-2. As a result, shrimp 13 in the unloading location 102 on channel 14-1 may need to be delivered to a first selected delivery location by sorting system 10, while shrimp 13 in the unloading location 102 on channel 14-2 may need to be delivered to a second or third selected delivery location. In such an instance, the unloader 16 associated with channel 14-1 may be actuated to deliver shrimp into receiver 20-1 for delivery to a first selected delivery location by rotating slide 30-1 such that slide end 34-1 is positioned above a guide chute associated with the first selected delivery location as described herein. Because shrimp 13 carried on clamp 12 of channel 14-2 at unloading location 102 has one or more different physical characteristics from shrimp 13 on channel 14-1, the unloader associated with channel 14-2 may be actuated to deliver shrimp 13 on channel 14-2 only after slide 30-1 has been rotated about its slide axis to position slide end 34-1 above a different guide chute associated with a different selected delivery location.

The channels 14-3 and 14-4 along with their respective unloaders 16 may be operated similarly to deliver the shrimp 13 carried on clamps 12 in channels 14-3 and 14-4 to the same or different selected delivery locations as needed based on one or more of the physical characteristics of the shrimp 13 as described herein.

Although the delivery apparatus 100 depicted in FIGS. 13-14 includes a pair of channels arranged to deliver shrimp into each of the receivers 20 of the sorting system 10, one or more alternative embodiments of delivery apparatus that may be used with the sorting systems described herein may include only a single channel delivering shrimp into each of the receivers 20 or, alternatively, may include three or more channels delivering shrimp into each of the receivers 20.

The controller 200 may also be configured to operate a slide actuator 238 associated with a first slide to rotate the first slide about its slide axis such that, as described herein, the first slide end is located above an optional first guide chute configured to deliver shrimp to a first selected delivery location of a set of delivery locations as described herein. The controller 200 may further be configured to operate a second slide actuator 238 associated with second slide to rotate the second slide about its slide axis such that the slide end of the second slide is located above an optional second guide chute configured to deliver shrimp to a second selected delivery location in set of delivery locations as described herein.

In one or more embodiments, the second delivery location may be the same delivery location as the first delivery location while in one or more alternative embodiments the second delivery location and the first delivery location may be different delivery locations among the set of delivery locations.

In one or more embodiments, the controller 200 may further be configured to operate the slide actuator 238 associated with first slide to rotate first slide about its slide axis such that the slide end of the first slide is positioned above an optional third guide chute configured to deliver shrimp passing through the third guide chute to a third selected delivery location after operating the slide actuator to rotate the first slide about its slide axis such that the first slide end is positioned above the first guide chute.

In one or more embodiments, the controller 200 may further be configured to operate the slide actuator 238 associated with the second slide to rotate second slide about its slide axis such that the slide end of the second slide is also positioned above the third guide chute configured to deliver shrimp passing through the third guide chute to the third selected delivery location after operating the slide actuator 238 to rotate the second slide about its slide axis such that the slide end of the second slide is positioned above the second guide chute configured to deliver shrimp to the second selected delivery location. In one or more embodiments, the slide ends of the first and second slides may be located above the third guide chute to deliver shrimp to the third selected delivery location at the same time.

All references and publications cited herein are expressly incorporated herein by reference in their entirety into this disclosure, except to the extent they may directly contradict this disclosure. Although specific illustrative embodiments have been described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims.

1. A sorting system comprising:
a first receiver defining a first passageway extending from a first receiving end to a first transfer end;
a second receiver defining a second passageway extending from a second receiving end to a second transfer end;
a first slide comprising a first tray located below the first transfer end, the first tray configured to receive a shrimp passing through the first receiver from the first receiving end to the first transfer end, wherein the first slide further comprises a first guide extending from the first tray to a first slide end located below the first tray;
a second slide comprising a second tray located below the second transfer end, the second tray configured to receive a shrimp passing through the second receiver from the second receiving end to the second transfer end, wherein the second slide further comprises a second guide extending from the second tray to a second slide end located below the second tray;
a first slide actuator operably connected to the first slide end configured to rotate the first slide about a first slide axis, wherein rotation of the first slide about the first slide axis moves the first slide end along a first arc about the first slide axis;
a second slide actuator operably connected to the second slide end configured to rotate the second slide about a second slide axis, wherein rotation of the second slide about the second slide axis moves the second slide end along a second arc about the second slide axis;
a plurality of delivery locations located below the first slide and the second slide, wherein movement of the first slide end along the first arc moves the first slide end above the plurality of delivery locations and movement of the second slide end along the second arc moves the second slide end above the plurality of delivery locations; and
a controller operably connected to the first slide actuator and the second slide actuator, the controller configured to:
operate the first slide actuator to rotate the first slide about the first slide axis such that the first slide end is positioned above a first delivery location of the plurality of delivery locations such that each shrimp passing through the first receiver is delivered to the first delivery location after passing along the first slide and exiting the first slide at the first slide end when the first slide end is positioned above the first delivery location;
operate the second slide actuator to rotate the second slide about the second slide axis such that the second slide end is positioned above a second delivery location of the plurality of delivery locations such that each shrimp passing through the second receiver is delivered to the second delivery location after passing along the second slide and exiting the second slide at the second slide end when the second slide end is positioned above the second delivery location;
operate the first slide actuator to rotate the first slide about the first slide axis such that the first slide end is positioned above the second delivery location such that each shrimp passing through the first receiver is delivered to the second delivery location after passing along the first slide and exiting the first slide at the first slide end when the first slide end is positioned above the second delivery location.

2. A system according to claim 1, wherein the controller is configured to operate the first slide actuator to rotate the first slide about the first slide axis such that the first slide end is positioned above a third delivery location of the plurality of delivery locations such that each shrimp passing through the first receiver is delivered to the third delivery location after passing along the first slide and exiting the first slide at the first slide end when the first slide end is positioned above the third delivery location.

3. A system according to claim 2, wherein the controller is configured to operate the second slide actuator to rotate the second slide about the second slide axis such that the second slide end is positioned above the third delivery location such that each shrimp passing through the second receiver is delivered to the third delivery location after passing along the second slide and exiting the second slide at the second slide end when the second slide end is positioned above the third delivery location.

4. A system according to claim 1, wherein the first slide, the first slide axis, and the first arc are configured to position the first slide end above any selected delivery location of the plurality of delivery locations.

5. A system according to claim 1, wherein the first slide axis passes through the first tray of the first slide and the second slide axis passes through the second tray of the second slide.

6. A system according to claim 1, wherein the controller is configured to:
receive a signal indicative of a first physical characteristic of each shrimp passing through the first receiver, wherein, optionally, the first physical characteristic is one of: a selected weight range, a selected length range, heading status, and shelling status; and
identify a selected delivery location of the plurality of delivery locations for each shrimp having the first physical characteristic passing through the first receiver based at least in part on the first physical characteristic.

7. A system according to claim 6, wherein the controller is configured to:
receive a signal indicative of the first physical characteristic of each shrimp passing through the second receiver; and
identify a second selected delivery location of the plurality of delivery locations for each shrimp having the first physical characteristic passing through the second receiver based at least in part on the first physical characteristic of each shrimp passing through the second receiver.

8. A system according to claim 7, wherein the controller is configured to operate the second slide actuator to rotate the second slide about the second slide axis such that the second slide end is positioned above the second selected delivery location such that each shrimp having the first physical characteristic passing through the second receiver is delivered to the second selected delivery location after passing along the second slide end exiting the second slide at the second slide end when the second slide end is positioned above the second selected delivery location.

9. A system according to claim 1, wherein the system comprises a plurality of guide chutes located between the first arc and the plurality of delivery locations, wherein the plurality of guide chutes are also located between the second arc and the plurality of delivery locations, wherein each guide chute of the plurality of guide chutes comprises an upper end and a lower end, wherein shrimp entering each guide chute of the plurality of guide chutes through the upper end of the guide chute pass through the guide chute and exit the guide chute through the lower end of the guide chute, wherein movement of the first slide end along the first arc moves the first slide end above the upper ends of the plurality of guide chutes, and wherein movement of the second slide end along the second arc moves the second slide end above the upper ends of the plurality of guide chutes.

10. A system according to claim 9, wherein each guide chute of the plurality of guide chutes is configured to deliver shrimp passing through the guide chute to only one selected delivery location of the plurality of delivery locations.

11. A system according to claim 9, wherein a selected guide chute of the plurality of guide chutes comprises a ramp, wherein shrimp delivered to the selected guide chute by the first slide move both laterally/horizontally and vertically along the ramp under the force of gravity towards the lower end of the selected guide chute, wherein shrimp delivered to the selected guide chute by the second slide move vertically under the force of gravity towards the lower end of the selected guide chute, and wherein shrimp delivered to the selected guide chute from both the first slide and the second slide are delivered to the same selected delivery location located directly beneath the lower end of the selected guide chute.

12. (canceled)

13. A method of sorting shrimp, the method comprising:
determining a physical characteristic of a first shrimp;
identifying a first selected delivery location of a plurality of delivery locations based at least in part on the physical characteristic of the first shrimp;
rotating a first slide about a first slide axis such that a first slide end of the first slide is positioned to deliver the first shrimp to the first selected delivery location;
delivering the first shrimp to a first tray of the first slide, wherein the first shrimp moves along the first slide from the first tray to the first slide end for delivery to the first selected delivery location under the force of gravity;
determining a physical characteristic of a second shrimp;
identifying a second selected delivery location of the plurality of delivery locations based at least in part on the physical characteristic of the second shrimp;
rotating a second slide about a second slide axis such that a second slide end of the second slide is positioned to deliver the second shrimp to the second selected delivery location; and
delivering the second shrimp to a second tray of the second slide, wherein the second shrimp moves along the second slide from the second tray to the second slide end for delivery to the second selected delivery location under the force of gravity.

14. A method according to claim 13, wherein the method comprises rotating the first slide about the first slide axis to deliver the first shrimp to the first selected delivery location before delivering the first shrimp to the first tray of the first slide.

15. A method according to claim 13, wherein the first selected delivery location and the second selected delivery location are the same delivery location when the physical characteristic of the first shrimp is the same as the physical characteristic of the second shrimp.

16. A method according to claim 13, wherein rotating the first slide about the first slide axis moves the first slide end along a first arc and rotating the second slide about the second slide axis moves the second slide end along a second arc, wherein the first arc and the second arc do not intersect.

17. A method according to claim 13, wherein the first slide axis and the second slide axis are aligned with each other and/or wherein the first slide axis and the second slide axis are oriented generally vertically.

18. A method according to claim 13, wherein the physical characteristic of the first shrimp is one of: a selected weight range, a selected length range, heading status, and shelling status.

19. A method according to claim 15, wherein the method comprises guiding the first shrimp to the first selected delivery location using a guide chute that moves the first shrimp laterally with respect to the direction of gravity after the first shrimp leaves the first slide end before the first shrimp reaches the first selected delivery station

20. A system according to claim 3, wherein the controller is configured to operate the first slide actuator and the second slide actuator such that the first slide end and the second slide end are both positioned above the third delivery location at the same time such that each shrimp passing through the first receiver and each shrimp passing through the second receiver is delivered to the third delivery location when the first slide end and the second slide end are both positioned above the third delivery location.

21. A system according to claim 1, wherein the controller is configured to:
receive a signal indicative of a first physical characteristic of each shrimp passing through the first receiver, wherein, optionally, the first physical characteristic is one of: a selected weight range, a selected length range, heading status, and shelling status; and
identify a selected delivery location of the plurality of delivery locations for each shrimp having the first physical characteristic passing through the first receiver based at least in part on the first physical characteristic;
operate the first slide actuator to rotate the first slide about the first slide axis such that the first slide end is positioned above the selected delivery location such that each shrimp having the first physical characteristic passing through the first receiver is delivered to the selected delivery location after passing along the first slide end exiting the first slide at the first slide end when the first slide end is positioned above the selected delivery location.

22. A system according to claim 21, wherein the controller is configured to:
receive a signal indicative of the first physical characteristic of each shrimp passing through the second receiver; and
identify a second selected delivery location of the plurality of delivery locations for each shrimp having the first physical characteristic passing through the second receiver based at least in part on the first physical characteristic of each shrimp passing through the second receiver;
wherein the selected delivery location and the second selected delivery location are the same delivery location of the plurality of delivery locations when the first physical characteristic of shrimp passing through the first receiver and the first physical characteristic of shrimp passing through the second receiver are the same;
and wherein the selected delivery location and the second selected delivery location are different delivery locations of the plurality of delivery locations when the first physical characteristic of shrimp passing through the first receiver and the first physical characteristic of shrimp passing through the second receiver are different.
